(19) United States
(12) Patent Application Publication
(10) Pub. No.: US 2026/0111056 A1
(43) Pub. Date: Apr. 23, 2026

(54) HEAD WEARABLE ELECTRONIC DEVICE

(71) Applicant: SAMSUNG ELECTRONICS CO., LTD., Suwon-si (KR)

(72) Inventors: Mihye NA, Suwon-si (KR); Hyunsoo KIM, Suwon-si (KR); Sungkwang YANG, Suwon-si (KR)

(73) Assignee: SAMSUNG ELECTRONICS CO., LTD., Suwon-si (KR)

(21) Appl. No.: 19/276,587

(22) Filed: Jul. 22, 2025

Related U.S. Application Data
(63) Continuation of application No. PCT/KR2025/009945, filed on Jul. 9, 2025.

(30) Foreign Application Priority Data
Oct. 22, 2024 (KR) 10-2024-0145057
Feb. 4, 2025 (KR) 10-2025-0013511

(51) Int. Cl. G06F 1/16; H04N 23/74; H04N 23/745

(52) U.S. Cl. CPC G06F 1/163; H04N 23/74; H04N 23/745

(57) ABSTRACT

There is disposed a head wearable electronic device including a housing, a tracking camera disposed in the housing, an infrared LED disposed in the housing, and a window cover disposed in front of the housing. The window cover includes a first stacked structure and at least one of a second stacked structure formed at a position corresponding to the tracking camera and a third stacked structure corresponding to the infrared LED, The first stacked structure includes a front scatter protection member disposed toward the exterior of the housing, a rear scatter protection member disposed toward the interior of the housing and a transparent member disposed between the front scatter protection member and the rear scatter protection member. The at least one of the second stacked structure and the third stacked structure is different from the first stacked structure.

### CROSS-REFERENCE TO RELATED APPLICATION(S)

This application is a continuation of an International application No. PCT/KR2025/009945 designating the United States, filed on Jul. 9, 2025, in the Korean Intellectual Property Receiving Office, which claims priority from Korean Patent Application No. 10-2024-0145057, filed on Oct. 22, 2024, and Korean Patent Application No. 10-2025-0013511, filed on Feb. 4, 2025, in the Korean Intellectual Property Office, the disclosures of each of which are incorporated by reference herein in their entireties.

### BACKGROUND

Various embodiments of the disclosure relate to a head wearable electronic device.

As technology advances, electronic devices have been developed to be worn by users so as to enhance portability and user accessibility.

In recent years, development efforts have been actively underway for head-mounted wearable electronic devices that may deliver virtual reality and/or mixed reality experiences through displays. The wearable electronic device may include various types of input devices to track the surrounding environment and an operation of the user. For example, the wearable electronic device may include at least one of a time of flight (ToF) sensor, a flicker sensor, an infrared LED, and a plurality of cameras as an input device.

The above-described information may be disposed as related art for the purpose of helping understanding of the disclosure. No claim or determination is made as to whether any of the foregoing is applicable as background art in relation to the disclosure.

### SUMMARY

According to an aspect of the disclosure, there is disposed a head wearable electronic device including: a housing formed with an open front and an open rear, a tracking camera disposed in the housing, an infrared LED disposed in the housing, a window cover disposed in front of the housing, the window cover including a first stacked structure and at least one of a second stacked structure formed at a position corresponding to the tracking camera and a third stacked structure corresponding to the infrared LED, wherein the first stacked structure includes: a front scatter protection member disposed toward the exterior of the housing; a rear scatter protection member disposed toward the interior of the housing; and a transparent member disposed between the front scatter protection member and the rear scatter protection member, and wherein the at least one of the second stacked structure and the third stacked structure is different from the first stacked structure.

### BRIEF DESCRIPTION OF DRAWINGS

FIG. 1 is a block diagram illustrating an electronic device in a network environment according to an embodiment of the disclosure;

FIG. 2 is a perspective view illustrating a head wearable electronic device according to an embodiment;

FIG. 3 is an exploded view illustrating some components of a head wearable electronic device according to an embodiment;

FIG. 4 is a plan view illustrating a window cover of a head wearable electronic device according to an embodiment;

FIG. 5 is a plan view illustrating a shroud of a head wearable electronic device according to an embodiment;

FIG. 6 is a front plan view illustrating a state in which a window cover and a shroud overlap in a head wearable electronic device according to an embodiment;

FIG. 7 is a cross-sectional view schematically illustrating a first stacked structure of a window cover, which is a component of a head wearable electronic device according to an embodiment;

FIGS. 8A and 8B are views schematically illustrating a second stacked structure of a window cover, which is a component of a head wearable electronic device according to an embodiment;

FIG. 9 is a cross-sectional view schematically illustrating a third stacked structure of a window cover, which is a component of a head wearable electronic device according to an embodiment;

FIG. 10 is a cross-sectional view schematically illustrating a window cover and a time of flight (ToF) window among the components of a head wearable electronic device according to an embodiment; and

FIG. 11 is a cross-sectional view schematically illustrating a window cover and a flicker window among the components of a head wearable electronic device according to an embodiment.

Reference may be made to the accompanying drawings in the following description, and specific examples that may be practiced are shown as examples within the drawings. Other examples may be utilized and structural changes may be made without departing from the scope of the various examples.

### DETAILED DESCRIPTION

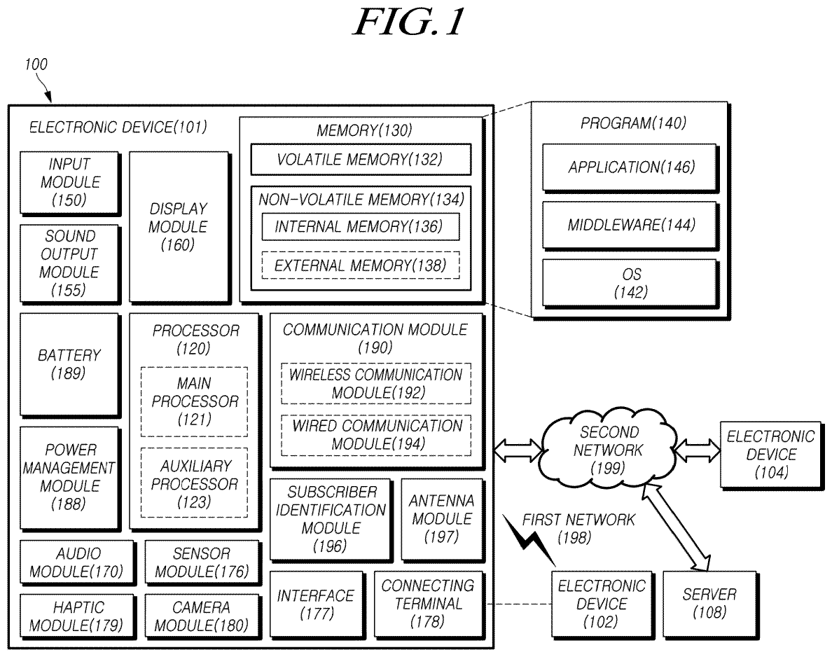

Various embodiments of the disclosure are merely exemplified herein with reference to FIGS. 1 to 11, to describe the principle of the disclosure, and should not be interpreted as limiting the scope of the disclosure. Those skilled in the art will understand that the principle of the disclosure may be implemented in any appropriately disposed system or device.

Hereinafter, embodiments of the disclosure are described in detail with reference to the drawings so that those skilled in the art to which the disclosure pertains may easily practice the disclosure. However, the disclosure may be implemented in other various forms and is not limited to the embodiments set forth herein. The same or similar reference denotations may be used to refer to the same or similar elements throughout the specification and the drawings. Further, for clarity and brevity, no description is made of well-known functions and configurations in the drawings and relevant descriptions.

FIG. 1 is a block diagram illustrating an electronic device in a network environment according to an embodiment of the disclosure.

Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In an embodiment, at least one (e.g., the connecting terminal 178) of the components may be omitted from the electronic device 101, or one or more other components may be added in the electronic device 101. In an embodiment, some (e.g., the sensor module 176, the camera module 180, or the antenna module 197) of the components may be integrated into a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be configured to use lower power than the main processor 121 or to be specified for a designated function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display 160 may include, for example, a display, a hologram device, or a projector and control circuitry to control a corresponding one of the display, hologram device, and projector. According to an embodiment, the display 160 may include a touch sensor configured to detect a touch, or a pressure sensor configured to measure the intensity of a force generated by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. The sensor module 176 may include, e.g., a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via a first network 198 (e.g., a short-range communication network, such as Bluetooth™, wireless-fidelity (Wi-Fi) direct, or infrared data association (IrDA)) or a second network 199 (e.g., a long-range communication network, such as a legacy cellular network, a 5G network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device). According to an embodiment, the antenna module 197 may include one antenna including a radiator formed of a conductor or conductive pattern formed on a substrate (e.g., a printed circuit board (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

According to an embodiment, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, instructions or data may be transmitted or received between the electronic device 101 and the external electronic device 104 via the server 108 coupled with the second network 199. The external electronic devices 102 or 104 each may be a device of the same or a different type from the electronic device 101. According to an embodiment, all or some of operations to be executed at the electronic device 101 may be executed at one or more of the external electronic devices 102, 104, or 108. In an example case in which the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The external electronic devices 102 and 104 each may be a device of the same or a different type from the electronic device 101. According to an embodiment, all or some of operations to be executed at the electronic device 101 may be executed at one or more of the external electronic devices 102, 104, or 108. In an example case in which the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. For example, the external electronic device 102 may render and transfer, to the electronic device 101, content data executed on an application, and the electronic device 101 receiving the data may output the content data to a display module. In an example case in which the electronic device 101 detects a motion of the user through, for example, an inertial measurement unit (IMU) sensor, the processor of the electronic device 101 may correct the rendering data received from the external electronic device 102 based on the motion information and output the corrected rendering data to the display module. Alternatively, the processor of the electronic device 101 may transfer the motion information to the external electronic device 102 and request rendering so that screen data is updated accordingly. According to various embodiments, the external electronic device 102 may be various types of devices, such as a smart phone or a case device capable of storing and charging the electronic device 101.

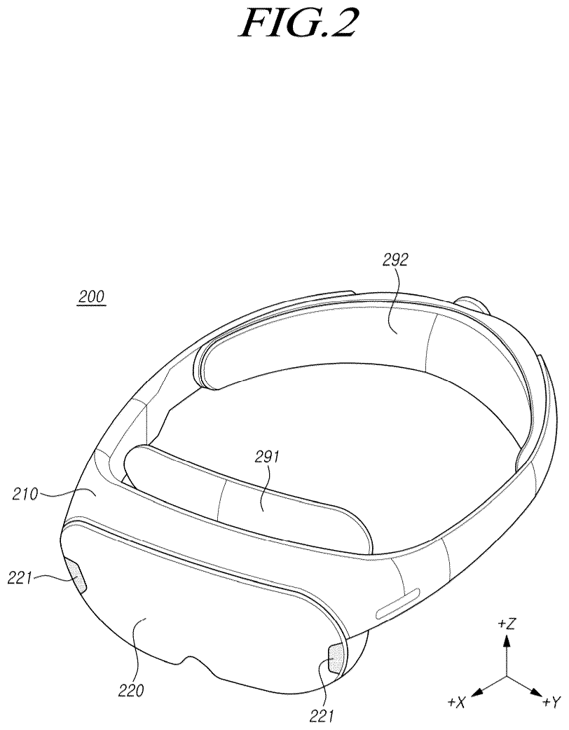

FIG. 2 is a perspective view illustrating a head wearable electronic device according to an embodiment.

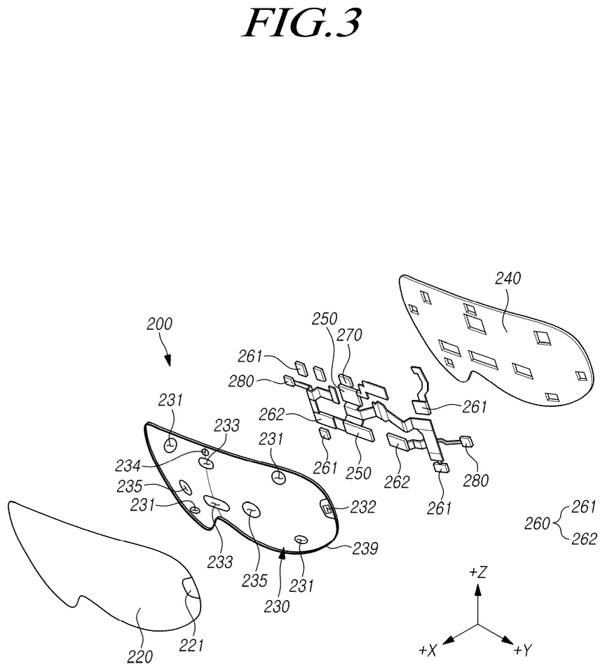

FIG. 3 is an exploded view illustrating some components of a head wearable electronic device according to an embodiment.

According to various embodiments, all features, components, and/or arrangement relationships between components illustrated in FIGS. 2 and 3 may be included alone or in combination with the features, components, and arrangement relationships between components described in other drawings of the disclosure. Likewise, all features, components, and/or arrangement relationships between components described in connection with FIGS. 1 and 4 to 11 may be included alone or in combination with the features, components, and arrangement relationships between components described in connection with FIGS. 2 and 3.

Referring to FIGS. 2 and 3, the head wearable electronic device 200 (e.g., the electronic device 101 of FIG. 1) according to an embodiment may be a wearable device such as a head-mounted device (HMD) that may be worn on a head of the user to provide an image in front of the eyes. For example, the image may be a virtual reality space image or an augmented reality space image. The head wearable electronic device 200 may be a device having a technology capable of providing the user with virtual reality (VR), augmented reality (AR), mixed reality (MR), and/or extended reality (XR) encompassing them.

According to an embodiment, the head wearable electronic device 200 may include at least one of a processor (e.g., the processor 120 of FIG. 1), memory (e.g., the memory 130 of FIG. 1), a display module (e.g., the display module 160 of FIG. 1), a charging module (e.g., the battery 189 of FIG. 1), or other components illustrated in FIG. 1. According to an embodiment, the head wearable electronic device 200 may further include other components necessary to provide a virtual reality, an augmented reality, a mixed reality, or an extended reality to the user.

According to an embodiment, the processor 120 may be electrically connected to other components to control other components. The processor 120 may perform various data processing or operations according to execution of various functions (e.g., operations, services, or programs) disposed by the head wearable electronic device 200. The processor 120 may perform various data processing or operations for displaying at least one virtual object related to real objects included in an image captured in a real space and/or a virtual object (e.g., an avatar) corresponding to the user in a virtual reality or augmented reality space. The processor 120 may perform various data processing or operations for representing user interaction or movement of a virtual object displayed in a virtual reality or augmented reality space.

According to an embodiment, the head wearable electronic device 200 may include at least one of a housing 210, a window cover 220, a shroud 230, a frame 240, a depth sensor 250, a camera module 260, a flicker sensor 270, and an infrared LED 280. However, the disclosure is not limited thereto, and as such, one or more components may be added, omitted or combined.

According to an embodiment, the housing 210 may form an external appearance of the head wearable electronic device 200. The housing 210 may form an accommodation space in which components may be disposed. The housing 210 may be disposed to surround the eyes of the head of the user in an example case in which the head wearable electronic device 200 worn by a user (e.g., the head wearable electronic device 200 may be mounted on a head of the user).

According to an embodiment, the housing 210 may be formed so that the front and rear sides of the housing 210 are open. Here, the rear side may refer to a direction (e.g., −X direction) toward the user in an example case in which the user wears the head wearable electronic device 200. The front side may refer to a direction (e.g., +X direction) opposite to the rear side.

According to an embodiment, the housing 210 may receive at least some of the components of the head wearable electronic device 200. For example, the components such as the shroud 230, the frame 240, the depth sensor 250, the camera module 260, the flicker sensor 270, the infrared LED 280, and the display may be disposed in the housing 210.

According to an embodiment, the window cover 220 may be disposed on the front side of the housing 210. According to an embodiment, the window cover 220 may be disposed to cover the front side of the housing 210. The window cover 220 may be disposed to seal the front opening of the housing 210. The window cover 220 may be formed of a material through which light passes. However, the disclosure is not limited thereto, and as such, the window cover 220 may be formed of another material. For example, the window cover 220 may be formed of a transparent material. The window cover 220 may include a curved surface. In an example case in which the window cover 220 is formed of a material through which light passes, the aesthetics of the overall appearance of the head wearable electronic device 200 may be enhanced. The window cover 220 may be referred to as a cover, a shield, an optical cover, a protective screen, or a transparent panel. The window cover 220 is described below in detail.

According to an embodiment, the window cover 220 may include an infrared (IR) transmissive portion 221. The IR transmissive portion 221 may be configured to increase the transmittance of the infrared band and decrease the transmittance of visible light. The IR transmissive portion 221 has a low transmittance of visible light to be seen with the naked eye as opaque or translucent. The IR transmissive portion 221 may be referred to as an optical filter or an infrared filter.

According to an embodiment, the shroud 230 may be disposed so that components received in the housing 210 are not visible from the outside (e.g., through the window cover 220). The shroud 230 may be disposed in the housing 210. For example, the shroud 230 may have a curved shape. For example, the shroud 230 may be referred to as a light blocking film, a screening member, a shielding member, a visor, or a masking member.

According to an embodiment, the shroud 230 may be disposed on the rear side of the window cover 220. The shroud 230 may be formed of a material where light is not projected. For example, the shroud 230 may be printed with opaque ink. For example, shroud 230 may include an opaque film.

According to an embodiment, the shroud 230 may include a rib 239. The rib 239 may extend along an edge of the shroud 230. The rib 239 may extend toward the window cover 220. The rib 239 may be formed to support the window cover 220. An end portion of the rib 239 and the window cover 220 may be adhered by an adhesive member. The rib 239 may be disposed to support an edge of the window cover 220. As the window cover 220 and the shroud 230 are adhered by the rib 239, a gap or space may be formed between the window cover 220 and the shroud 230. By the space between the window cover 220 and the shroud 230, the user may feel a sense of depth about the front of the exterior of the head wearable electronic device 200, thereby enhancing the aesthetics.

According to an embodiment, the shroud 230 may include a plurality of holes 231, 232, 233, 234, and 235. The plurality of holes 231, 232, 233, 234, and 235 may be formed in portions corresponding to a camera or a sensor among the components disposed in the housing 210. A detailed description of the plurality of holes 231, 232, 233, 234, and 235 may be found below.

According to an embodiment, the frame 240 may be disposed in the housing 210. The frame 240 may be disposed to support or fix components disposed in the housing 210. For example, the frame 240 may be disposed to support or fix the depth sensor 250, the camera module 260, the flicker sensor 270, and the infrared LED 280. The frame 240 may be formed of a plastic, metal and/or carbon fiber material.

According to an embodiment, the depth sensor 250 may be configured to transmit a signal and receive a signal reflected from a subject. The depth sensor 250 may be used for identifying a distance to the subject, such as the time of flight (TOF). The depth sensor 250 may be configured to detect the distance or depth to the subject using a signal (near-infrared, ultrasonic, or laser). The depth sensor 250 may detect the distance or depth to the subject based on the time of flight of the signal measured by emitting a signal from the transmission unit and detecting the signal reflected by the reception unit. The head wearable electronic device 200 may obtain three-dimensional (3D) depth information about the surrounding environment using the depth sensor 250. The depth sensor 250 may be referred to or replaced with a TOF camera, a TOF sensor, an infrared camera, or a distance sensor.

According to an embodiment, the depth sensor 250 may be disposed in the housing 210. The depth sensor 250 may be disposed behind the shroud 230 (e.g., in the −X direction).

According to an embodiment, the depth sensor 250 may include an indirect time of flight (iToF) sensor and/or a direct time of flight (dToF) sensor. The iToF sensor may be configured to measure the distance to an object by modulating the phase of a periodic signal (e.g., infrared). The iToF sensor may calculate the distance by measuring the signal phase change of the light reflected from the object. The dToF sensor may be configured to calculate the distance by directly measuring the time taken for the light (e.g., infrared light) radiated to the object to be reflected and returned.

According to an embodiment, the camera module 260 may capture a still image and/or a video. According to an embodiment, the camera module 260 (e.g., the camera module 180 of FIG. 1) may include at least one first camera 261 and at least one second camera 262. The camera module 260 may be referred to as an optical device.

According to an embodiment, the at least one first camera 261 may track at least one of a hand of the user, torso of the user, or other body portions of the user. At least one first camera 261 may be disposed to obtain an image of the surrounding environment for tracking. The first camera 261 may be referred to as a tracking camera.

According to an embodiment, at least one first camera 261 may be disposed in the housing 210. At least one first camera 261 may be disposed behind the shroud 230 (e.g., in the −X direction). For example, the first camera 261 may be a global shutter (GS) camera or a rolling shutter (RS) camera. At least one first camera 261 may perform a simultaneous localization and mapping (SLAM) operation through depth capturing. At least one first camera 261 may perform spatial recognition and/or movement recognition for three degrees of freedom (3DoF) and/or six degrees of freedom (6DoF).

According to an embodiment, at least one first camera 261 may be disposed adjacent to an inner circumferential surface of the housing 210. Each of the at least one first camera 261 may be positioned along the edge of the shroud 230 to capture a broad range of image data covering the front, sides, and top and bottom of the housing 210. Each of the at least one first camera 261 may be positioned at a portion corresponding to an edge of the window cover 220. As an example, the number of the at least one first camera 261 may be four. Each of the four first cameras 261 may be disposed at a left upper end, a right upper end, a right upper end, and a right lower end. As an example, the number of the at least one first camera 261 may be two. Each of the two first cameras 261 may be disposed on the left side and the right side.

According to an embodiment, the first camera 261 (e.g., a tracking camera) may be sensitive to wavelengths of visible light and/or infrared light. The infrared sensitivity of the first camera 261 may be substantially the same as the wavelength emitted by the infrared LED 280.

According to an embodiment, the head wearable electronic device 200 may track the movement of the user by recognizing a fixed object or a specific pattern (wall, floor, or furniture) around the user using at least one first camera 261. Accordingly, the head wearable electronic device 200 may obtain data on a direction in which the user moves, a moving distance, a rotation angle, or the like.

According to an embodiment, the second camera 262 may be disposed to obtain an image of the front of the housing 210. The second camera 262 may be disposed in the housing 210. The second camera 262 may be disposed behind the shroud 230 (e.g., in the −X direction). The second camera 262 may perform an auto-focusing function and/or an optical image stabilization function. The second camera 262 may be, e.g., a global shutter (GS) camera or a rolling shutter (RS) camera. The second camera 262 may be, e.g., an RGB camera. The second camera 262 may be a high resolution camera such as a high resolution (HR) or a photo video (PV).

According to an embodiment, the second camera 262 may be disposed to allow the user to view the external environment. For example, even in a case in which the user is wearing the head wearable electronic device 200, the external real world may be viewed through the second camera 262. The image obtained from the second camera 262 may be disposed to the user through the display module 160. The second camera 262 may be referred to, e.g., as a pass-through camera.

According to an embodiment, the head wearable electronic device 200 may include two second cameras 262. The two second cameras 262 may be disposed on portions corresponding to a left eye and a right eye of the user, respectively, but the disclosure is not limited thereto.

According to an embodiment, the head wearable electronic device 200 may provide information about the image obtained from the second camera 262 to the user in real-time through the display module 160.

According to an embodiment, the flicker sensor 270 may be disposed in the housing 210. The flicker sensor 270 may be disposed behind the shroud 230. The flicker sensor 270 may detect ambient light (e.g., visible light). The flicker sensor 270 may include a photodetector capable of detecting a change in intensity of ambient light over time. In an example case in which an artificial light source is positioned in an environment where the user uses the head wearable electronic device 200, the light source may emit light at a specific frequency. For example, the specific frequency may be 60 Hz, but the disclosure is not limited thereto. The photodetector of the flicker sensor 270 may detect a change in intensity of a specific frequency (e.g., 60 Hz) of light emitted from the artificial light source.

According to an embodiment, the processor 120 may match the light source frequency and the frame speed of the image capture operation by adjusting the clock or timing signal related to the operation of the camera module 260 using information detected by the flicker sensor 270. The flicker sensor 270 may be referred to as an ambient light frequency sensor.

According to an embodiment, the infrared light emitting diode (LED) 280 may be used as an auxiliary light by radiating infrared rays to the front. The infrared LED 280 may serve as an auxiliary light for exhibiting the tracking performance of the first camera 261 (or tracking camera) in a dark environment. The infrared LED 280 may be referred to as an infrared illuminator.

According to an embodiment, the processor 120 may control the infrared LED 280 to be turned off in an example case in which the ambient environmental illuminance is greater than or equal to a reference value and the infrared LED 280 to be turned on in an example case in which the ambient environmental illuminance is smaller than the reference value. The reference value may be a fixed or predetermined value. However, the disclosure is not limited thereto.

According to an embodiment, the head wearable electronic device 200 may include a light sealing portion (light seal) 291. The light sealing portion 291 may be disposed to extend rearward from the housing 210. The light sealing portion 291 may extend from a circumference of the housing 210. The light sealing portion 291 may be disposed to extend from the housing 210 toward the face of the so that external light does not flow into the housing 210. The light sealing portion 291 may be detachably coupled to the housing 210.

According to an embodiment, the head wearable electronic device 200 may include a mounting member 292. The mounting member 292 may be coupled to the housing 210. The mounting member 292 may be disposed to surround the circumference of the head of the user when mounted or worn by the user. The mounting member 292 may be referred to as, e.g., a head mount.

According to an embodiment, the mounting member 292 may include a strap and/or a band. The strap may include, e.g., plastic, metal or other structural material that forms a hard shape. The band may be formed of a flexible material such as rubber, silicone or elastomer, for example.

According to an embodiment, the head wearable electronic device 200 may include a display module 160. The display module 160 may be disposed in the housing. The display module 160 may be disposed to display a screen toward the rear side. The display module 160 may be used to display visual content to the user (e.g., still images and/or videos, photos, videos transmitted from the camera module, text, graphics, movies, games, and/or other visual content). The head wearable electronic device 200 may provide a virtual reality image or an augmented reality image to the user using the display module 160. For example, the display module 160 may be a curved display. A real world image captured by the second camera 262 and computer-generated content electronically overlaid on the real image may be displayed on the display module 160.

For example, the display module 160 may include, but is not limited to, a liquid crystal display (LCD), a digital mirror device (DMD), a liquid crystal on silicon (LCoS), a light emitting diode on silicon (LEDoS), an organic light emitting diode (OLED), or a micro light emitting diode (micro LED). In an example case in which the display is formed of one of a liquid crystal display, a digital mirror device, or a liquid crystal on silicon display, the electronic device may include a light source that radiates light to the screen output area of the display. In an example case in which the display is capable of generating light by itself (e.g., in an example case in which the display is formed of one of an organic light emitting diode or a micro LED), the electronic device may provide a good quality virtual image to the user even when display does not include a separate light source. In an example case in which the display is implemented as an organic light emitting diode or a micro LED, a light source may be unnecessary, and thus the electronic device may be lightweight.

According to an embodiment, the head wearable electronic device 200 may further include a lens. The lens may have a role of adjusting the focus so that the screen output to the display is visible to the eye of the user. The lens may be one of various types of lenses, such as a Fresnel lens, a pancake lens, or a multi-channel lens, for example.

According to an embodiment, the head wearable electronic device 200 may include a printed circuit board (PCB). The printed circuit board may be disposed in the housing 210. The printed circuit board may be electrically connected to each electronic component (e.g., the camera module 260, the display module (e.g., the display module 160 of FIG. 1), and the sensor module (e.g., the sensor module 176 of FIG. 1)) through the FPCB. The printed circuit board may have a form including a first substrate, a second substrate, and an interposer disposed between the first substrate and the second substrate.

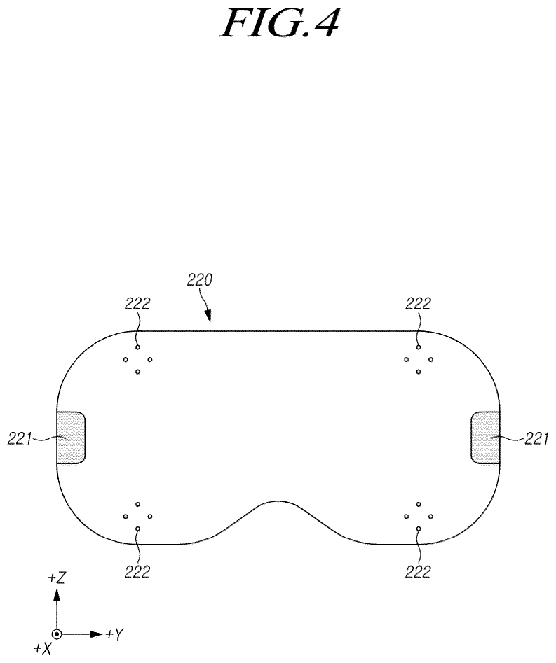

FIG. 4 is a plan view illustrating a window cover of a head wearable electronic device according to an embodiment.

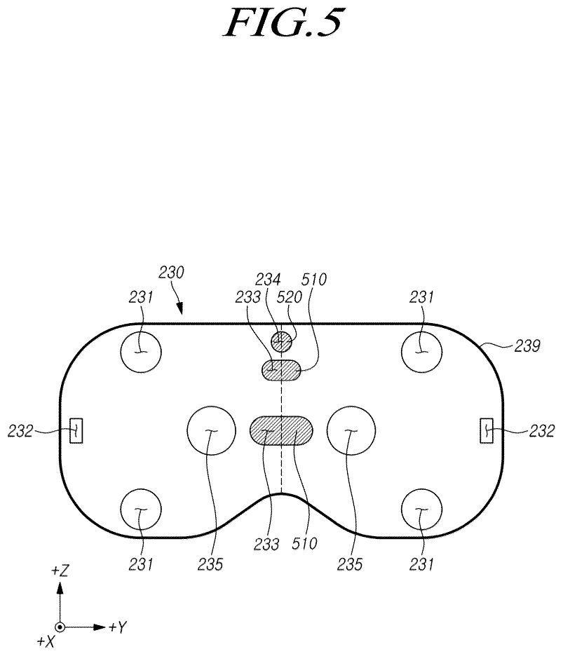

FIG. 5 is a plan view illustrating a shroud of a head wearable electronic device according to an embodiment.

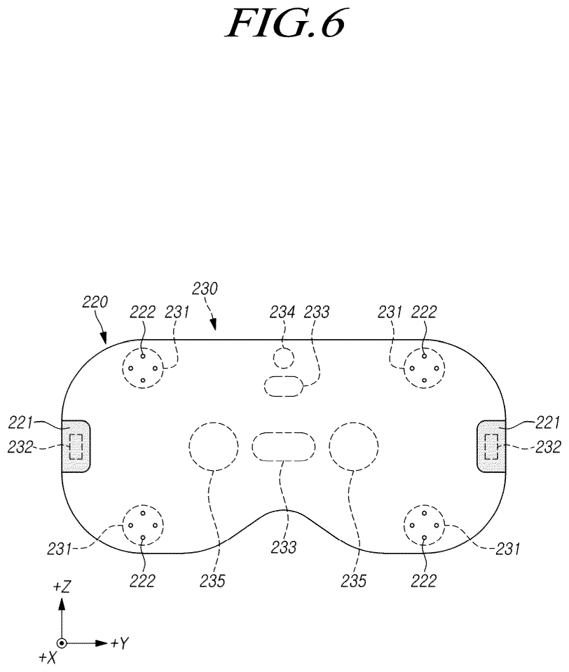

FIG. 6 is a front plan view illustrating a state in which a window cover and a shroud overlap in a head wearable electronic device according to an embodiment.

According to various embodiments, all features, components, and/or arrangement relationships between components illustrated in FIGS. 4 to 6 may be included alone or in combination with the features, components, and arrangement relationships between components described in other drawings of the disclosure. Likewise, all features, components, and/or arrangement relationships between components described in connection with FIGS. 1 to 3 and 7 to 11 may be included alone or in combination with the features, components, and arrangement relationships between components described in connection with FIGS. 4 to 6.

Referring to FIGS. 4 to 6, a head wearable electronic device (e.g., the electronic device 101 of FIG. 1 or the head wearable electronic device 200 of FIG. 2) may include a window cover 220 and a shroud 230. The window cover 220 may be disposed in front of the shroud 230 (e.g., +X direction). The window cover 220 and the shroud 230 may be disposed to be spaced apart from each other by a predetermined distance, but the disclosure is not limited thereto.

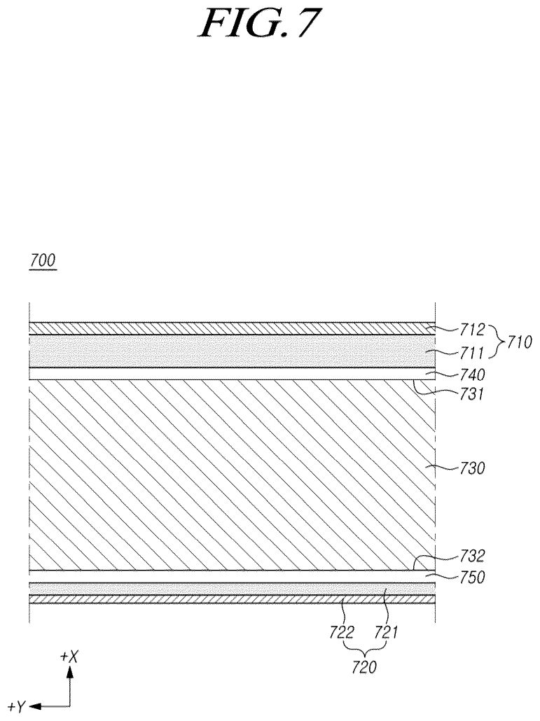

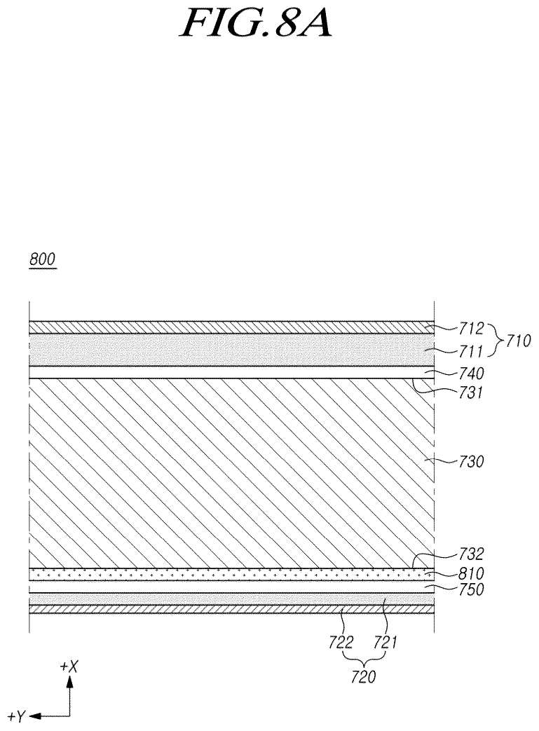

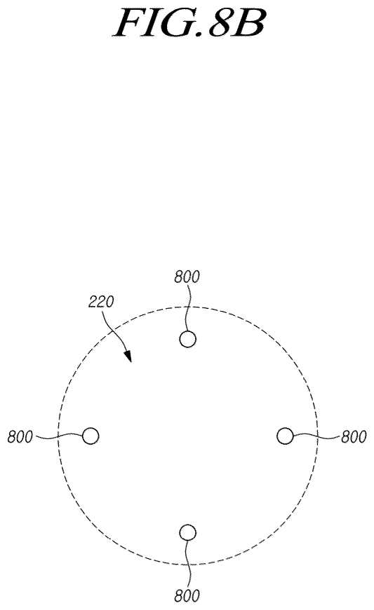

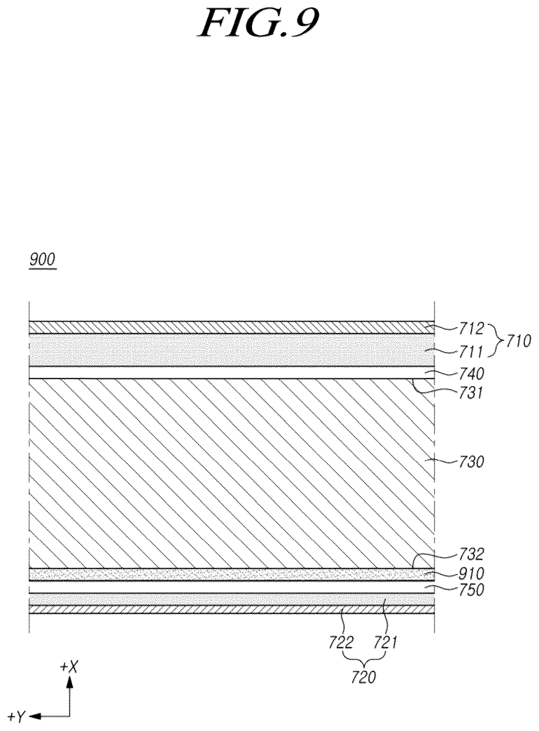

According to an embodiment, the window cover 220 may include a transparent member (e.g., the transparent member 730 of FIG. 7) formed of a transparent material. The window cover 220 may be partially formed of a material through which light passes. For example, the window cover 220 may include, but is not limited to, a polymer such as transparent plastic, sapphire or glass material. For example, the first stacked structure (e.g., the first stacked structure 700 of FIG. 7) and the second stacked structure (e.g., the second stacked structure 800 of FIG. 8A) to be described in the window cover 220 may be formed of a material through which visible light and infrared rays pass. For example, the third stacked structure (e.g., the third stacked structure 900 of FIG. 9) to be described below in the window cover 220 may have a lower visible light transmittance than the first stacked structure 700 or the second stacked structure 800.

According to an embodiment, the window cover 220 may include a fiducial mark 222. The fiducial mark 222 may be disposed on the surface of the transparent member (e.g., the transparent member 730 of FIG. 8A). The fiducial mark 222 may be configured to be transparent. In an example case in which the fiducial mark 222 is implemented with transparent ink, it may be difficult for the user to recognize the fiducial mark 222 with the naked eye.

According to an embodiment, the fiducial mark 222 may be disposed on a portion corresponding to the first camera (e.g., the first camera 261 of FIG. 3). The fiducial mark 222 may be disposed to overlap the first camera 261 in the forward/backward direction (e.g., the X-axis direction). The fiducial mark 222 may be disposed at a portion of the shroud 230 corresponding to the first hole 231. The fiducial mark 222 may be disposed to overlap the first hole 231 of the shroud 230 in the forward/backward direction (e.g., the X-axis direction).

According to an embodiment, the fiducial mark 222 may be disposed in the field of view (FOV) range of the first camera 261. The fiducial mark 222 may be disposed within an area in which the angle of view of the first camera 261 touches the window cover 220. The position of the fiducial mark 222 may be determined in advance according to the position of the first camera 261.

According to an embodiment, the fiducial mark 222 may be used in the process of calibrating the first camera 261. Calibration is required for the first camera 261 used as the tracking camera, and for this purpose, the position of the camera should be identified. The fiducial mark 222 may be disposed within the field of view of the first camera 261. The head wearable electronic device 200 may calibrate the first camera 261 based on the position of the fiducial mark 222 captured by the first camera 261. In an example case in which the arrangement of the fiducial mark 222 captured by the first camera 261 is misaligned or the position is moved as a whole, the misalignment of the first camera 261 may be grasped, and calibration may be performed. In an example case in which the fiducial mark 222 is implemented by a transparent ink layer, it is difficult for the user to identify the fiducial mark 222 with the naked eye, so that the aesthetics of the appearance of the head wearable electronic device 200 may not be deteriorated.

According to an embodiment, there may be a plurality of fiducial marks 222. A plurality of fiducial marks 222 may be formed or disposed at a position corresponding to one first camera 261. As an example, four fiducial marks 222 may be disposed in a cross shape as illustrated. For example, two fiducial marks 222 may be disposed on the same horizontal line (e.g., Y-axis), and the remaining two fiducial marks 222 may be disposed on the same vertical line (e.g., Z-axis). The virtual figure connecting the four fiducial marks 222 may have a rectangular or diamond shape, but the disclosure is not limited thereto. The four fiducial marks 222 may be disposed with respect to a virtual intersection where the horizontal line and the vertical line meet. However, this is exemplary, and the number and arrangement of the fiducial marks 222 are not limited thereto.

According to an embodiment, the IR transmissive portion 221 may be disposed on a portion corresponding to an infrared LED (e.g., the infrared LED 280 of FIG. 3). The IR transmissive portion 221 may be positioned to overlap the infrared LED 280 in the forward/backward direction (e.g., the X-axis direction). There may be a plurality of IR transmissive portions 221. The number of IR transmissive portions 221 may correspond to the number of infrared LEDs 280. The IR transmissive portion 221 may have a printed layer, a coating layer, or a thin film form having low visible light transmittance.

According to an embodiment, the IR transmissive portion 221 may be positioned adjacent to the edge of the window cover 220. The plurality of IR transmissive portions 221 may be disposed as illustrated in FIG. 4. One IR transmissive portion 221 may be positioned on the left (e.g., the +Y direction) edge of the window cover 220. The other IR transmissive portion 221 may be positioned on the right (e.g., the −Y direction) edge of the window cover 220. In an example case in which the IR transmissive portion 221 appears opaque or colored, the IR transmissive portion 221 may be positioned at the edge of the window cover 220 to reduce the appearance of the head wearable electronic device 200.

According to an embodiment, the shroud 230 may be disposed on the rear side (e.g., the −X direction) of the window cover 220. The shroud 230 is formed of an opaque material and may serve as a blocking film or an screening film for preventing electronic components disposed in the housing 210 from being visible from the outside. The shroud 230 may be, e.g., injection-molded. The shroud 230 may be referred to as a bracket, a device, a light shielding film, or a light shielding portion.

According to an embodiment, the shroud 230 may include a plurality of holes 231, 232, 233, 234, and 235. Each of the plurality of holes 231, 232, 233, 234, and 235 may be referred to as a first hole 231, a second hole 232, a third hole 233, a fourth hole 234, and a fifth hole 235 according to the position. The plurality of holes 231, 232, 233, 234 and 235 may be formed through a portion of the shroud 230.

According to an embodiment, the first hole 231 may be formed at a position corresponding to the first camera (e.g., the first camera 261 of FIG. 3). The first hole 231 may be positioned in front of the first camera 261. The first hole 231 may be positioned to overlap the first camera 261 in the forward/backward direction (e.g., the X-axis direction). As many first hole 231 as the number of first cameras 261 disposed in the housing 210 may be formed. A plurality of first holes 231 may be formed. For example, the plurality of first holes 231 may be formed at a left upper end, a left lower end, a right upper end and/or a right lower end, respectively.

According to an embodiment, the second hole 232 may be formed at a position corresponding to an infrared LED (e.g., the infrared LED 280 of FIG. 3). The second hole 232 may be positioned in front of the infrared LED 280. The second hole 232 may be positioned to overlap the infrared LED 280 in the forward/backward direction (e.g., the X-axis direction). The second hole 232 may be disposed at an edge of the shroud 230. The second hole 232 may be formed at a left (e.g., the +Y direction) edge and/or a right (e.g., the −Y direction) edge of the shroud 230, but the disclosure is not limited thereto. As many second holes 232 as the number of infrared LEDs 280 disposed in the housing 210 may be formed.

According to an embodiment, the third hole 233 may be formed at a position corresponding to the depth sensor (e.g., the depth sensor 250 of FIG. 3). The third hole 233 may be positioned in front of the depth sensor 250. The third hole 233 may be positioned to overlap the depth sensor 250 in the forward/backward direction (e.g., the X-axis direction). The third hole 233 may be positioned at a central portion of the shroud 230. The third hole 233 may be positioned at a portion between the left eye and the right eye of the user when mounted or worn by the user, but the disclosure is not limited thereto. As many third holes 233 as the number of depth sensors 250 disposed in the housing 210 may be formed.

According to an embodiment, the fourth hole 234 may be formed at a position corresponding to a flicker sensor (e.g., the flicker sensor 270 of FIG. 3). The fourth hole 234 may be positioned in front of the flicker sensor 270. The fourth hole 234 may be positioned to overlap the flicker sensor 270 in the forward/backward direction (e.g., the X-axis direction). The fourth hole 234 may be positioned, e.g., at an upper end portion (e.g., an end portion in the +Z direction) in the central portion of the shroud 230, but the disclosure is not limited thereto.

According to an embodiment, the fifth hole 235 may be formed at a position corresponding to the second camera (e.g., the second camera 262 of FIG. 3). The fifth hole 235 may be positioned in front of the second camera 262. The fifth hole 235 may be positioned to overlap the second camera 262 in the forward/backward direction (e.g., an X-axis direction). The fifth hole 235 may be formed on the left and right sides of the shroud 230, respectively. The fifth hole 235 may be positioned in a portion corresponding to the left eye and the right eye of the user when mounted, but the disclosure is not limited thereto. As many fifth holes 235 as the number of second cameras 262 disposed in the housing 210 may be formed.

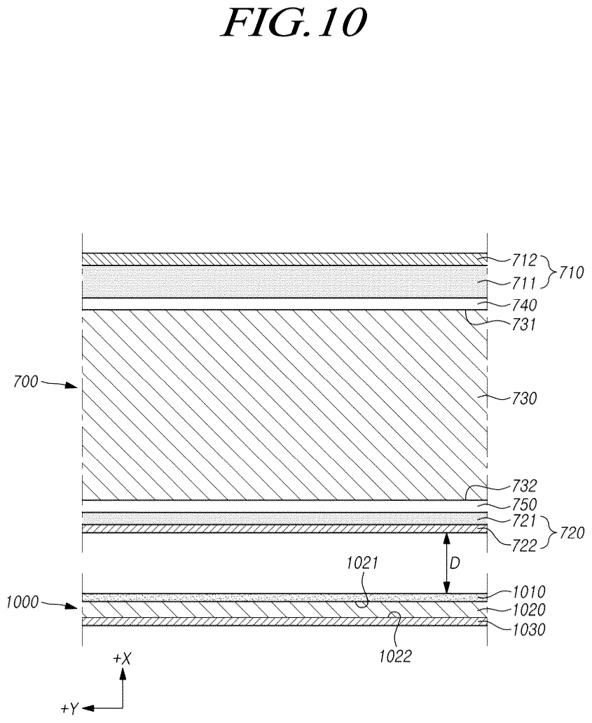

According to an embodiment, the head wearable electronic device 200 may further include a depth window 510. The depth window 510 may be disposed in the third hole 233. The depth window 510 may be disposed to seal the third hole 233. In an example case in which the first camera 261 tracks the head of the user, the hand of the user, or other body portions of the user through the window cover 220 and the depth window 510 having a transparent material and a curved structure, a crosstalk may occur due to light reflection, light scattering, or multi-path light reflection caused by structural characteristics of the window cover 220, thereby deteriorating tracking performance. In the disclosure, an anti-reflective coating layer (e.g., the anti-reflective coating layer 1030 of FIG. 10) is disposed behind the depth window 510 (e.g., in the −X direction) to mitigate performance degradation caused by crosstalk.

According to an embodiment, the depth window 510 may be formed of a material that decreases the transmittance of the visible light band. The depth window 510 may be formed of a colored material. The color of the depth window 510 may correspond to the color of the shroud 230. A detailed structure of the depth window 510 is described with reference to FIG. 10.

According to an embodiment, the head wearable electronic device 200 may further include a flicker window 520. The flicker window 520 may be disposed in the fourth hole 234. The flicker window 520 may be disposed to seal the fourth hole 234. In an example case in which the flicker sensor 270 is a sensor that detects a frequency of an external light source, only the frequency band of visible light may be used. In an example case in which the flicker sensor 270 detects the external light source through the window cover 220 having a transparent material and a curved structure, a crosstalk may occur due to light reflection, light scattering, or multi-path light reflection caused by structural characteristics of the window cover 220, thereby deteriorating the detection performance of the flicker sensor 270. In an example case in which a crosstalk occurs due to the IR band frequency output from the first camera 261 and the infrared LED 280, the flicker sensor 270 may cause misrecognition. According to an embodiment of the disclosure, the performance degradation of the flicker sensor 270 due to the IR band frequency may be mitigated by additionally configuring the flicker window 520 behind the window cover 220 (e.g., in the −X direction).

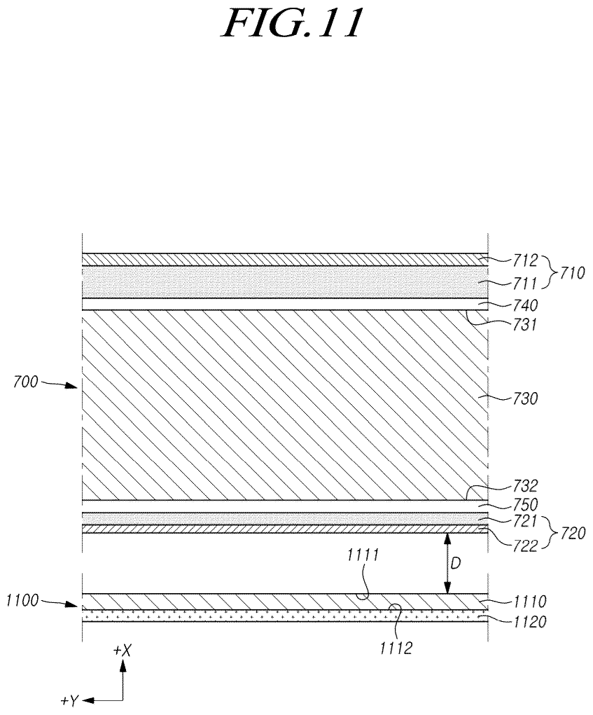

According to an embodiment, the flicker window 520 may be formed of a material that reduces or blocks the transmittance of the IR band. A detailed structure of the flicker window 520 is described with reference to FIG. 11.

FIG. 7 is a cross-sectional view schematically illustrating a first stacked structure of a window cover, which is a component of a head wearable electronic device according to an embodiment.

According to various embodiments, all features, components, and/or arrangement relationships between components illustrated in FIG. 7 may be included alone or in combination with the features, components, and arrangement relationships between components described in other drawings of the disclosure. Likewise, all features, components, and/or arrangement relationships between components described in connection with FIGS. 1 to 6 and 8A to 11 may be included alone or in combination with the features, components, and arrangement relationships between components described in connection with FIG. 7.

Referring to FIG. 7, the head wearable electronic device (e.g., the electronic device 101 of FIG. 1 or the head wearable electronic device 200 of FIG. 2) may include a window cover (e.g., the window cover 220 of FIG. 3). A portion of the window cover 220 may have a first stacked structure 700.

According to an embodiment, the window cover 220 may include a front scatter protection member (or scatter proof member) 710, a rear scatter protection member 720, and a transparent member 730. The first stacked structure 700 may be configured by sequentially stacking the front scatter protection member 710, the transparent member 730, and the rear scatter protection member 720.

According to an embodiment, the first stacked structure 700 may include the front scatter protection member 710 disposed to face the outside of the housing 210 (e.g., in the +X direction), the rear scatter protection member 720 disposed to face the inside of the housing 210 (e.g., in the −X direction), and the transparent member 730 disposed between the front scatter protection member 710 and the rear scatter protection member 720.

According to an embodiment, the front scatter protection member 710 may be disposed to face the outside (e.g., +X direction) of the housing 210. The front scatter protection member 710 may be thicker than the rear scatter protection member 720. The front scatter protection member 710 may prevent the transparent member 730 from being scattered in an example case in which the transparent member 730 is damaged due to an external impact. The front scatter protection member 710 may include one of a front scatter prevention coating or a front scatter prevention film coated on the transparent member 730. In an example case in which the front scatter protection member 710 is coated on the transparent member 730, the first adhesive member 740 may be omitted. The front scatter protection member 710 may be referred to as a front scatter prevention member.

According to an embodiment, the front scatter protection member 710 may be disposed to cover at least a portion of the side surface of the transparent member 730. The front scatter protection member 710 may prevent scattering from occurring on the side surface of the transparent member 730 in an example case in which the transparent member 730 is damaged.

According to an embodiment, the front scatter protection member 710 may include a first scatter prevention layer 711. The first scatter prevention layer 711 may include, but is not limited to, at least one of polycarbonate (PC) or polyethylene terephthalate (PET). The first scatter prevention layer 711 may have a thickness of about 80 μm to 120 μm, but the disclosure is not limited thereto.

According to an embodiment, the front scatter protection member 710 may include a surface protection layer 712. The surface protection layer 712 may be disposed on the front surface of the first scatter prevention layer 711. The surface protection layer 712 may be disposed to supplement hardness of the first scatter prevention layer 711. For example, the surface protection layer 712 may have a thickness of about 40 μm to about 60 μm, but the disclosure is not limited thereto. The surface protection layer 712 may include, e.g., poly methyl methacrylate (PMMA). Here, the front surface of the first scatter prevention layer 711 may refer to a surface facing a direction (e.g., +X direction) opposite to the direction facing the transparent member 730. The surface protection layer 712 may be omitted.

According to an embodiment, the surface protection layer 712 may be one of a hard coating layer or a protective film. In an example case in which the surface protection layer 712 is a hard coating layer, the surface protection layer 712 may be coated on the front surface of the first scatter prevention layer 711. In an example case in which the surface protection layer 712 is a protective film, the surface protection layer 712 may be attached to the front surface of the first scatter prevention layer 711 by an adhesive member (e.g., optically clear adhesive (OCA)).

According to an embodiment, the surface protection layer 712 may be disposed to cover at least a portion of the side surface of the transparent member 730. The surface protection layer 712 may be disposed to protect at least a portion of the side surface of the transparent member 730.

According to an embodiment, the front scatter protection member 710 may include an anti-fingerprint (AF) layer. For example, the AF layer may be disposed on the front surface of the first scatter prevention layer 711, or may be disposed on the surface protection layer 712. The AF layer may be coated on the surface protection layer 712 to form a coating layer, or may be attached onto the surface protection layer 712 in the form of a film.

According to an embodiment, the front scatter protection member 710 may include an ultraviolet blocking layer, an anti-fouling layer, or a waterproof layer. The ultraviolet blocking layer, the anti-fouling layer, or the waterproof layer may be disposed on the front surface of the first scatter prevention layer 711, for example.

According to an embodiment, the rear scatter protection member 720 may be disposed to face the inside (e.g., the −X direction) of the housing 210. The rear scatter protection member 720 may protect the transparent member 730 from being scattered in an example case in which the transparent member 730 is damaged due to an external impact. The rear scatter protection member 720 may include one of a rear scatter prevention coating or a rear scatter prevention film coated on the transparent member 730. In an example case in which the rear scatter protection member 720 is coated on the transparent member 730, the second adhesive member 750 may be omitted. The rear scatter protection member 720 may be referred to as a rear scatter prevention member.

According to an embodiment, the rear scatter protection member 720 may be disposed to cover at least a portion of the side surface of the transparent member 730. In an example case in which the transparent member 730 is damaged, the rear scatter protection member 720 may prevent scattering from occurring on the side surface of the transparent member 730.

According to an embodiment, the rear scatter protection member 720 may include a second scatter prevention layer 721. The second scatter prevention layer 721 may include at least one of polycarbonate and polyethylene terephthalate. The second scatter prevention layer 721 may have a thickness smaller than that of the first scatter prevention layer 711. For example, the second scatter prevention layer 721 may have a thickness of about 40 μm to about 60 μm, but the disclosure is not limited thereto.

According to an embodiment, the rear scatter protection member 720 may further include an anti-reflective coating layer 722. The anti-reflective coating layer 722 may be disposed on the rear surface of the rear scatter protection member 720. Here, the rear surface of the anti-reflective coating layer 722 may refer to a surface facing a direction (e.g., the −X direction) opposite to the direction facing the transparent member 730. For example, the anti-reflective coating layer 722 may have a thickness of about 0.30 μm to about 0.50 μm, but the disclosure is not limited thereto. The anti-reflective coating layer 722 may be formed in the form of a film or coating.

According to an embodiment, the transparent member 730 may be disposed between the front scatter protection member 710 and the rear scatter protection member 720. The front scatter protection member 710 may be disposed on the front surface 731 of the transparent member 730. The rear scatter protection member 720 may be disposed on the rear surface 732 of the transparent member 730. The transparent member 730 may be formed of a transparent material. For example, the transparent member 730 may be one of a polymer such as a transparent plastic, a sapphire, or glass. The transparent member 730 may be formed in a curved surface. The transparent member 730 may have a thickness of about 700 μm to about 900 μm, but the disclosure is not limited thereto.

According to an embodiment, the transparent member 730 and the front scatter protection member 710 may be adhered by the first adhesive member 740. According to an embodiment, the transparent member 730 and the rear scatter protection member 720 may be adhered by the second adhesive member 750. Each of the first adhesive member 740 and the second adhesive member 750 may be one of an optically clear adhesive (OCA), a pressure sensitive adhesive (PSA), a UV-curable adhesive, a silicone adhesive, an epoxy adhesive, or an acrylic adhesive.

According to an embodiment, in an example case in which the transparent member 730 is formed of a polymer material, the front scatter protection member 710 may be replaced with a protective film or a surface protection layer for preventing scratches. According to an embodiment, in an example case in which the transparent member 730 is formed of a polymer material, the rear scatter protection member 720 may be omitted.

FIGS. 8A and 8B are views schematically illustrating a second stacked structure of a window cover, which is a component of a head wearable electronic device according to an embodiment.

According to various embodiments, all features, components, and/or arrangement relationships between components illustrated in FIGS. 8A and 8B may be included alone or in combination with the features, components, and arrangement relationships between components described in other drawings of the disclosure. Likewise, all features, components, and/or arrangement relationships between components described in connection with FIGS. 1 to 9 and 9 to 11 may be included alone or in combination with the features, components, and arrangement relationships between components described in connection with FIGS. 8A and 8B.

FIG. 8A is a cross-sectional view illustrating a second stacked structure. FIG. 8B is a plan view illustrating a portion of a window cover 220 to which a second stacked structure is applied.

Referring to FIGS. 8A and 8B, the head wearable electronic device (e.g., the electronic device 101 of FIG. 1 or the head wearable electronic device 200 of FIG. 2) may include a window cover (e.g., the window cover 220 of FIG. 3). A portion of the window cover 220 may have a second stacked structure 800. The second stacked structure 800 may be different from the first stacked structure (e.g., the first stacked structure 700 of FIG. 7) and the third stacked structure (e.g., the third stacked structure 900 of FIG. 9).

The same reference numbers are used to denote substantially the same components as the above-described components among the components of FIGS. 8A and 8B.

According to an embodiment, the window cover 220 may include a front scatter protection member 710, a rear scatter protection member 720, a transparent member 730, and a fiducial mark 810 (e.g., the fiducial mark 222 of FIG. 6).

According to an embodiment, the second stacked structure 800 may include a front scatter protection member 710 disposed to face the outside of the housing 210 (e.g., in the +X direction), a rear scatter protection member 720 disposed to face the inside of the housing 210 (e.g., in the −X direction), a transparent member 730 disposed between the front scatter protection member 710 and the rear scatter protection member 720, and at least one fiducial mark 810 disposed on the rear surface 732 of the transparent member 730. However, the disclosure is not limited thereto, and the fiducial mark 810 may be disposed on the front surface 731 of the transparent member 730.

According to an embodiment, the window cover 220 may have a second stacked structure 800 different from the first stacked structure (e.g., the stacked structure 700 of FIG. 7) at each position corresponding to the first camera (e.g., the first camera 261 of FIG. 3).

According to an embodiment, at least one fiducial mark 810 may be applied or disposed on the surface of the transparent member 730. The fiducial mark 810 may be a transparent material (or transparent ink). The fiducial mark 810 may be disposed on the rear surface 732 of the transparent member 730, but is not limited thereto, and may also be disposed on the front surface 731 of the transparent member 730. After the fiducial mark 810 is disposed on the rear surface 732 or the front surface 731 of the transparent member 730, the rear scatter protection member 720 or the front scatter protection member 710 may be coupled to the rear surface 732 or the front surface 731 of the transparent member 730. For example, the rear scatter protection member 720 or the front scatter protection member 710 may be disposed on the rear surface 732 or the front surface 731 of the transparent member 730.

According to an embodiment, as illustrated in FIG. 8B, the second stacked structure 800 may be formed at various positions to implement the fiducial marks 810 on the window cover 220. For example, in order to implement four fiducial marks 810 disposed in a cross shape, four second stacked structures 800 may be similarly disposed in a cross shape.

FIG. 9 is a cross-sectional view schematically illustrating a third stacked structure of a window cover, which is a component of a head wearable electronic device according to an embodiment.

According to various embodiments, all features, components, and/or arrangement relationships between components illustrated in FIG. 9 may be included alone or in combination with the features, components, and arrangement relationships between components described in other drawings of the disclosure. Likewise, all features, components, and/or arrangement relationships between components described in connection with FIGS. 1 to 8B and 10 and 11 may be included alone or in combination with the features, components, and arrangement relationships between components described in connection with FIG. 9.

Referring to FIG. 9, the head wearable electronic device (e.g., the electronic device 101 of FIG. 1 or the head wearable electronic device 200 of FIG. 2) may include a window cover (e.g., the window cover 220 of FIG. 3). A portion of the window cover 220 may have a third stacked structure 900. The third stacked structure 900 may be different from the first stacked structure (e.g., the first stacked structure 700 of FIG. 7) and the second stacked structure (e.g., the second stacked structure 800 of FIG. 8A).

According to an embodiment, the window cover 220 may have the third stacked structure 900 different from the first stacked structure (e.g., the stacked structure 700 of FIG. 7) and/or the second stacked structure (e.g., the stacked structure 800 of FIG. 8A) at each position corresponding to the infrared LED (e.g., the infrared LED 280 of FIG. 3).

According to an embodiment, the IR transmissive portion 910 (e.g., the IR transmissive portion 221 of FIG. 4) may be disposed on the surface of the transparent member 730. The IR transmissive portion 910 may be disposed on the rear surface 732 of the transparent member 730. However, the disclosure is not limited thereto, and as such, the IR transmissive portion 910 may be disposed on the front surface 731 of the transparent member 730. The rear surface 732 of the transparent member 730 may be a surface in a direction (e.g., the −X direction) from the transparent member 730 toward the rear scatter protection member 720. The IR transmissive portion 910 may be configured to selectively pass infrared rays by filtering a specific frequency domain. The IR transmissive portion 910 may be applied in the form of a film on the surface of the transparent member 730 by a method such as sputtering, chemical vapor deposition, or physical vapor deposition. According to an embodiment, in the process of manufacturing the window cover 220, the IR transmissive portion 910 may be disposed on the rear surface 732 of the transparent member 730, and the rear scatter protection member 720 may be coupled to the rear surface 732 of the transparent member 730. For example, after the IR transmissive portion 910 is disposed on the rear surface 732 of the transparent member 730, the rear scatter protection member 720 may be disposed on the rear surface 732 of the transparent member 730. According to an embodiment, in the process of manufacturing the window cover 220, the IR transmissive portion 910 may be disposed on the front 731 of the transparent member 730, and the front scatter protection member 710 may be coupled to the front 731 of the transparent member 730. For example, after the IR transmissive portion 910 is disposed on the front 731 of the transparent member 730, and the front scatter protection member 710 may be disposed on the front 731 of the transparent member 730.

FIG. 10 is a cross-sectional view schematically illustrating a window cover and a depth window among components of a head wearable electronic device according to an embodiment.

According to various embodiments, all features, components, and/or arrangement relationships between components illustrated in FIG. 10 may be included alone or in combination with the features, components, and arrangement relationships between components described in other drawings of the disclosure. Likewise, all features, components, and/or arrangement relationships between components described in connection with FIGS. 1 to 9 and 11 may be included alone or in combination with the features, components, and arrangement relationships between components described in connection with FIG. 10.

Referring to FIG. 10, the head wearable electronic device (e.g., the electronic device 101 of FIG. 1 or the head wearable electronic device 200 of FIG. 2) according to an embodiment may include a window cover 220 and a depth window 1000 (e.g., the depth window 510 of FIG. 5).

According to an embodiment, a portion of the window cover 220 that corresponds to or overlaps the depth window 1000 may have a first stacked structure 700.

According to an embodiment, the window cover 220 and the depth window 1000 may be disposed to be spaced apart from each other by a predetermined distance D. For example, an air gap may be formed between the window cover 220 and the depth window 1000. For example, a transparent index matching material may be disposed in a space formed between the window cover 220 and the depth window 1000. However, the disclosure is not limited thereto, and the window cover 220 and the depth window 1000 may be disposed to at least partially contact each other.

According to an embodiment, the depth window 1000 may include an anti-fingerprint coating 1010, an anti-reflection coating 1030, and a first sub-transparent member 1020. The first sub-transparent member 1020 may be formed of a transparent material.

The anti-fingerprint coating 1010 may be disposed on the front surface 1021 of the first sub-transparent member 1020. Here, the front surface 1021 of the first sub-transparent member 1020 may be a surface in a direction (e.g., the +X direction) toward the window cover 220.

The anti-reflection coating 1030 may be disposed on the rear surface 1022 of the first sub-transparent member 1020. The anti-reflection coating 1030 may mitigate crosstalk due to light reflection. Here, the rear surface 1022 of the first sub-transparent member 1020 may be a surface facing the opposite direction (e.g., the −X direction) of the front surface 1021.

FIG. 11 is a cross-sectional view schematically illustrating a window cover and a flicker window among components of a head wearable electronic device according to an embodiment.

According to various embodiments, all features, components, and/or arrangement relationships between components illustrated in FIG. 11 may be included alone or in combination with the features, components, and arrangement relationships between components described in other drawings of the disclosure. Likewise, all features, components, and/or arrangement relationships between components described in connection with FIGS. 1 to 10 may be included alone or in combination with the features, components, and arrangement relationships between components described in connection with FIG. 11.

Referring to FIG. 11, the head wearable electronic device (e.g., the electronic device 101 of FIG. 1 or the head wearable electronic device 200 of FIG. 2) according to an embodiment may include a window cover 220 and a flicker window 1100 (e.g., the flicker window 520 of FIG. 5).

According to an embodiment, the window cover 220 and the flicker window 1100 may be disposed to be spaced apart from each other by a predetermined distance D. For example, an air gap may be formed between the window cover 220 and the flicker window 1100. For example, a transparent index matching material may be disposed in a space formed between the window cover 220 and the flicker window 1100. However, the disclosure is not limited thereto, and the window cover 220 and the flicker window 1100 may be disposed to at least partially contact each other.

According to an embodiment, the flicker window 1100 may include a second sub-transparent member 1110 and an infrared blocking coating 1120. The infrared blocking coating 1120 may be disposed to contact the second sub-transparent member 1110. The infrared blocking coating 1120 may be disposed on one of the front surface 1111 or the rear surface 1112 of the second sub-transparent member 1110.

Aspects and/or objects of the disclosure are not limited to the foregoing, and other unmentioned aspects and/or objects would be apparent to one of ordinary skill in the art.

A head wearable electronic device according to an embodiment may include a housing (e.g., the second housing 210 of FIG. 2) formed with an open front and an open rear, a window cover e.g., the window cover 220 of FIG. 2 disposed to cover the front of the housing 210, a tracking camera (e.g., the tracking camera 261 of FIG. 3) disposed within the housing 210, and an infrared LED (e.g., the infrared LED 280 of FIG. 3) disposed within the housing 210. A portion of the window cover 220 may form a first stacked structure (e.g., the first stacked structure 700 of FIG. 7) comprising a front scatter protection member (e.g., the front scatter protection member 710 of FIG. 7) disposed toward the exterior of the housing 210, a rear scatter protection member (e.g., the rear scatter protection member 720 of FIG. 7) disposed toward the interior of the housing 210, and a transparent member (e.g., the transparent member 730 of FIG. 7) between the front scatter protection member 710 and the rear scatter protection member 720. The window cover 220 may include a second stacked structure (e.g., the second stacked structure 800 of FIG. 8A) and/or third stacked structure (e.g., the third stacked structure 900 of FIG. 9) formed at positions corresponding to the tracking camera 261 or the infrared LED 280, respectively, and different from the first stacked structure 700.

According to an embodiment, the second stacked structure 800 may include at least one fiducial mark (e.g., the fiducial mark 810 of FIG. 8A) on the surface of the transparent member 730 at a position corresponding to the tracking camera 261.

According to an embodiment, the at least one fiducial mark 810 may be on the rear surface of the transparent member 730.

According to an embodiment, the third stacked structure 900 may include an IR transmission portion (e.g., the IR transmission portion 910 of FIG. 9) on the surface of the transparent member 730 at a position corresponding to the infrared LED 280, which increases transmittance in the infrared frequency domain and decreases transmittance in the visible light frequency domain.

According to an embodiment, the IR transmission portion 910 may be on a rear side of the transparent member 730.

According to an embodiment, the IR transmission portion 910 may be adjacent to an edge of the window cover 220.

According to an embodiment, the head wearable electronic device 200 may further include a shroud (e.g., the shroud 230 of FIG. 5) on a rear side of the window cover 220, and including a plurality of holes (e.g., the plurality of holes 231, 232, 233, 234, 235 of FIG. 5).

According to an embodiment, the plurality of holes 231, 232, 233, 234, 235 of the shroud 230 may include a first hole 231 formed through at a position corresponding to the tracking camera 261 and a second hole 232 formed through at a position corresponding to the infrared LED 280.

According to an embodiment, the head wearable electronic device 200 may further include a depth sensor (e.g., the depth sensor 250 of FIG. 3) on a rear side of the shroud 230.

According to an embodiment, the shroud 230 may include a third hole 233 formed through at a position corresponding to the depth sensor 250. The head wearable electronic device 200 may further include a depth window (e.g., the depth window 1000 of FIG. 10) in the third hole 233, and including an anti-fingerprint coating (e.g., the anti-fingerprint coating 1010 of FIG. 10), an anti-reflection coating (e.g., the anti-reflection coating 1030 of FIG. 10), and a first sub-transparent member (e.g., the sub-transparent member 1020 of FIG. 10) between the anti-fingerprint coating 1010 and the anti-reflection coating 1030.

According to an embodiment, the window cover 220 and the depth window 1000 may be disposed with a predetermined gap therebetween.

According to an embodiment, the head wearable electronic device 200 may further include a flicker sensor (e.g., the flicker sensor 270 of FIG. 3) on a rear side of the shroud 230.

According to an embodiment, the shroud 230 may include a fourth hole 234 formed through at a position corresponding to the flicker sensor 270. The head wearable electronic device may further include a flicker window (e.g., the flicker window 1100 of FIG. 11) in the fourth hole 234, and including a second sub-transparent member (e.g., the second sub-transparent member 1110 of FIG. 11), and an infrared blocking coating (e.g., the infrared blocking coating 1120 of FIG. 11) in contact with the second sub-transparent member 1110 and configured to block infrared light.

According to an embodiment, the window cover 220 and the flicker window 1100 may be disposed with a predetermined gap therebetween.

According to an embodiment, the head wearable electronic device 200 may further include a camera module (e.g., the camera module 262 of FIG. 3) on a rear side of the shroud 230 and configured to capture a front of the housing 210.

According to an embodiment, the shroud 230 may include a fifth hole 235 formed through at a position corresponding to the camera module 262.

According to an embodiment, the front scatter protection member 710 may be thicker than the rear scatter protection member 720.

According to an embodiment, the front scatter protection member 710 may include a first scatter prevention layer (e.g., the first scatter prevention layer 711 of FIG. 7), and a surface protection layer (e.g., the surface protection layer 712 of FIG. 7) on a front side of the first scatter prevention layer 711.

According to an embodiment, the rear scatter protection member 720 may include a second scatter prevention layer (e.g., the second scatter prevention layer 721 of FIG. 7), and an anti-reflection layer (e.g., the anti-reflection layer 722 of FIG. 7) on a rear side of the second scatter prevention layer 721.

According to an embodiment, the tracking camera 261 may be configured to track a position of a hand of a user, torso of the user, or a part of a body of the user.

According to one or more embodiments of the disclosure, in an example case in which the head wearable electronic device (e.g., the electronic device 101 of FIG. 1 or the head wearable electronic device 200 of FIG. 2) performs a specific operation, it may mean that various pieces of hardware included in the head wearable electronic device, e.g., a micro controlling unit (MCU), a field programmable gate array (FPGA), an application specific integrated circuit (ASIC), or the processor 120 such as a microprocessor or application processor (AP), perform the specific operation. According to an embodiment, the processor 120 may include processing circuitry. In an example case in which the head wearable electronic device performs a specific operation, it may mean that the processor 120 controls other hardware to perform the specific operation. In an example case in which the head wearable electronic device performs a specific operation, it may mean that the processor 120 or other hardware perform the specific operation as at least one instruction for performing the specific operation, stored in the storage circuit (e.g., the memory 130) of the head wearable electronic device, is executed. The at least one instruction stored in the memory 130 of the head wearable electronic device may, when executed by the processor 120, enable the head wearable electronic device to perform at least one operation individually or collectively.

The terms as used herein are disposed merely to describe some embodiments thereof, but are not intended to limit the disclosure. As used herein, the singular forms “a,” “an,” and “the” are intended to include the plural forms as well, unless the context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, the term ‘and/or’ should be understood as encompassing any and all possible combinations by one or more of the enumerated items. As used herein, the terms “include,” “have,” and “comprise” are used merely to designate the presence of the feature, component, part, or a combination thereof described herein, but use of the term does not exclude the likelihood of presence or adding one or more other features, components, parts, or combinations thereof. As used herein, the terms “first” and “second” may modify various components regardless of importance and/or order and are used to distinguish a component from another without limiting the components.

As used herein, the terms “configured to” may be interchangeably used with the terms “suitable for,” “having the capacity to,” “designed to,” “adapted to,” “made to,” or “capable of” depending on circumstances. The term “configured to” does not essentially mean “specifically designed in hardware to. ” Rather, the term “configured to” may mean that a device can perform an operation together with another device or parts. For example, a ‘device configured (or set) to perform A, B, and C’ may be a dedicated device to perform the corresponding operation or may mean a general-purpose device capable of various operations including the corresponding operation.

Meanwhile, the terms “upper side”, “lower side”, and “front and rear directions” used in the disclosure are defined with respect to the drawings, and the shape and position of each component are not limited by these terms.

In the disclosure, the above-described description has been made mainly of specific embodiments, but the disclosure is not limited to such specific embodiments, but should rather be appreciated as covering all various modifications, equivalents, and/or substitutes of various embodiments.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140 in FIG. 1) including one or more instructions that are stored in a storage medium (e.g., internal memory 136 in FIG. 1 or external memory 138 in FIG. 1) that is readable by a machine (e.g., the electronic device 101 of FIG. 1). For example, a processor (e.g., the processor 120 of FIG. 1) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The storage medium readable by the machine may be disposed in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and disposed in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. In an example, case in which the computer program product is distributed online, at least part of the computer program product may be temporarily generated or at least temporarily stored in the machine-readable storage medium, such as memory of a server of the manufacturer, a server of the application store, or a relay server.

According to various embodiments, each component (e.g., a module or a program) of the above-described components may include a single entity or multiple entities. Some of the plurality of entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. A head wearable electronic device comprising:
a housing formed with an open front and an open rear;
a tracking camera disposed in the housing;
an infrared LED disposed in the housing; and
a window cover disposed in front of the housing, the window cover comprising a first stacked structure and at least one of a second stacked structure formed at a position corresponding to the tracking camera and a third stacked structure corresponding to the infrared LED;
wherein the first stacked structure comprises:
a front scatter protection member disposed toward the exterior of the housing;
a rear scatter protection member disposed toward the interior of the housing; and
a transparent member disposed between the front scatter protection member and the rear scatter protection member, and
wherein the at least one of the second stacked structure and the third stacked structure is different from the first stacked structure.

2. The head wearable electronic device of claim 1,
wherein the second stacked structure comprises at least one fiducial mark on a surface of the transparent member at the position corresponding to the tracking camera.

3. The head wearable electronic device of claim 2,
wherein the at least one fiducial mark is on a rear surface of the transparent member.

4. The head wearable electronic device of claim 1,
wherein the third stacked structure comprises an infrared (IR) transmission portion on the surface of the transparent member at a position corresponding to the infrared LED, and
wherein the IR transmission portion is configured to increase transmittance in the infrared frequency domain and decrease transmittance in the visible light frequency domain.

5. The head wearable electronic device of claim 4,
wherein the IR transmission portion is on a rear side of the transparent member.

6. The head wearable electronic device of claim 4,
wherein the IR transmission portion is adjacent to an edge of the window cover.

7. The head wearable electronic device of claim 1,
further comprising a shroud on a rear side of the window cover, the shroud including a plurality of holes.

8. The head wearable electronic device of claim 7,
wherein the plurality of holes of the shroud comprise:
a first hole formed through at the position corresponding to the tracking camera; and
a second hole formed through at the position corresponding to the infrared LED.

9. The head wearable electronic device of claim 8,
further comprising a depth sensor on a rear side of the shroud.

10. The head wearable electronic device of claim 9,
wherein the shroud comprises a third hole formed through at a position corresponding to the depth sensor, and
wherein the head wearable electronic device further comprises a depth window in the third hole, the depth window comprising:
an anti-fingerprint coating,
an anti-reflection coating configured to selectively transmit infrared wavelengths, and
a first sub-transparent member between the anti-fingerprint coating and the anti-reflection coating.

11. The head wearable electronic device of claim 10,
further comprising a gap disposed between the window cover and the depth window.

12. The head wearable electronic device of claim 10,
further comprising a flicker sensor on a rear side of the shroud.

13. The head wearable electronic device of claim 12,
wherein the shroud comprises a fourth hole formed through at a position corresponding to the flicker sensor, and
wherein the head wearable electronic device further comprises a flicker window in the fourth hole, the flicker window comprising:
a second sub-transparent member, and
an infrared blocking coating in contact with the second sub-transparent member and configured to block infrared light.

14. The head wearable electronic device of claim 13,
further comprising a gap disposed between the window cover and the flicker window.

15. The head wearable electronic device of claim 13,
further comprising a camera module on a rear side of the shroud and configured to capture a front of the housing.

16. The head wearable electronic device of claim 15,
wherein the shroud comprises a fifth hole formed through at a position corresponding to the camera module.

17. The head wearable electronic device of claim 1,
wherein the front scatter protection member is thicker than the rear scatter protection member.

18. The head wearable electronic device of claim 1,
wherein the front scatter protection member comprises:
a first scatter prevention layer, and
a surface protection layer on a front side of the first scatter prevention layer.

19. The head wearable electronic device of claim 1,
wherein the rear scatter protection member comprises:
a second scatter prevention layer, and
an anti-reflection layer on a rear side of the second scatter prevention layer.

20. The head wearable electronic device of claim 1,
wherein the tracking camera is configured to track a position of a hand of a user, torso of a user or a body part of a user.
